(19) United States
(12) Patent Application Publication
(10) Pub. No.: US 2005/0247780 A1
(43) Pub. Date: Nov. 10, 2005

(54) Electronic shelf label and sign holder

(76) Inventor: Michael G. Lowry, The Woodlands, TX (US)

Correspondence Address: JACOBSON HOLMAN PLLC, 400 SEVENTH STREET N.W., SUITE 600, WASHINGTON, DC, 20004, US

(21) Appl. No.: 11/117,478

(22) Filed: Apr. 29, 2005

Related U.S. Application Data
(60) Provisional application No. 60/566,086, filed on Apr. 29, 2004.

(51) Int. Cl. G06K 15/00

(52) U.S. Cl. 235/383

(57) ABSTRACT

An electronic shelf label holder for holding large electronic shelf labels (ESLs) on a base member in one of several distinct orientations. The electronic label holder includes retention plates for retaining two ESLs in back-to-back relationship. A generally cylindrical mounting member supports the ESL on the base member and includes attachment fingers for attaching the ESL to a corresponding base plate in at least three orientations.

This application claims the benefit and priority of provisional application Ser. No. 60/566,086 filed Apr. 29, 2004, the contents of which are incorporated by reference herein.

### BACKGROUND OF THE INVENTION

1. Field of the Invention

This invention relates to electronic shelf label (ESL) holders for mounting to base plates of various configurations used in connection with retail merchandising. The ESL holder is mountable to the base plate in at least three different orientations so that the ESL can be angularly positioned to face at different angles for viewing. The ESL holder also includes slots for retaining promotional signage.

2. Description of the Related Art

Electronic shelf labels are increasingly utilized in retail establishments in place of, or in addition to, paper and plastic information-carrying labels. These ESLs are generally integrated with an in-store processor or a free-standing controller that communicates with file information supporting the store's point of sale system. The ESL system may include low voltage communication electronics or communication base stations located in store ceilings away from the store operations. The ESLs are positioned throughout the store to identify an item's retail price and other information of interest to the consumer and/or for use by the store's inventory system. Price changes can be initiated through the controller to update item price files.

Electronic shelf labels, attachable to ESL holders which, in turn, are attachable to the front edge of store shelving are known in the air. As described in commonly-assigned, pending application Ser. No. 10/448,049 filed on May 30, 2003, the subject matter of which is incorporated herein in its entirety by reference, an ESL such as those produced by NCR under its DecisioNet™ trademark are shown mounted to shelving, including C-channels. Among the embodiments disclosed includes an ESL holder member that engages with an attachment member which in turn is connected to the shelving or C-channel thereof. The attachment member includes a multiplicity of T-shaped protrusions and the holder includes a plurality of fingers that define gaps that are either snapped over or slid about the T-shaped protrusions. Thus, the holder can be positioned at different angular orientations with respect to the attachment member.

In U.S. Pat. No. 6,119,990 issued Sep. 19, 2000, an electronic shelf label holder is described to include an adaptor where the holder is connected with the adaptor in different locations through a separate fastener element.

The ESL holders described above are attachable to shelf components such as the C-channels or directly to the front edge of the shelving. However, a need has arisen for using ESLs outside the context of direct connection to shelving components but, rather, on a base, including a free-standing base, that can be oriented in different directions and freely mounted in various positions.

### SUMMARY OF THE INVENTION

It is a primary object of the present invention to provide highly versatile ESL holders particularly adapted for positioning on a base plate in multiple orientations.

A further object of the present invention is to provide an ESL holder that interengages with base plate configurations instead of the front edges of merchandise shelves. It is still further an object of the present invention to provide such ESL holder with a means for attaching the holder to the base at different angles depending on the position of the ESL relative to the eye of the viewer. That is, the ESL can be oriented to face perpendicular to the viewer, and angled for reading above the mounting level and angled for reading at a position below the mounting level, as well as the same level as the viewer.

Other and further objects, features, and advantages of the invention will become apparent from the ensuing description and claims taken in conjunction with the attached drawings.

### BRIEF DESCRIPTION OF THE DRAWINGS

These and other objects, features and many of the attendant advantages of this invention will be better understood by those with ordinary skill in the art in connection with the following detailed description of the preferred embodiments and the accompanying drawings wherein:

FIG. 1 is an exploded perspective view of an ESL, ESL holder, and base plate;

FIG. 2 is a perspective view of an assembled ESL and ESL holder mounted to a base plate;

FIG. 3 is a cross-sectional end view of a pair of ESLs, ESL holder and base plate;

FIG. 4 is substantially identical to FIG. 3, but shows a slightly different engagement with the base plate;

FIG. 5 depicts the ESL holder inserted into the base plate at a counterclockwise angle; and

FIG. 6 depicts the ESL holder inserted into the base plate at a clockwise angle.

Like reference characters refer to like parts throughout the several views of the drawings.

### DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

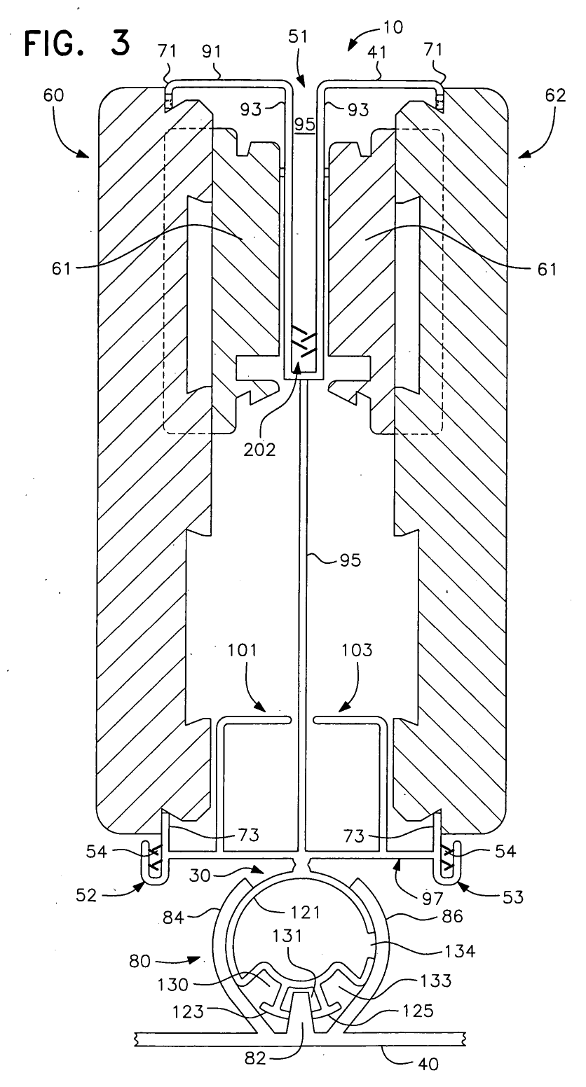

Referring now to the drawings, the electronic shelf label (ESL) holder of the present invention is designated generally by the reference numeral 10 and is comprised of three major components: an ESL retaining portion 20, a base plate engagement or mounting portion 30 for orienting the holder 10 in different positions relative to the base plate, and sign retention elements 51, 52, 53. The holder 10 is preferably extruded, relatively rigid, plastics material sufficiently robust to receive and carry at least two ESL devices 60, 62, as shown in FIG. 3. The specific construction of the ESL 60, 62 forms no part of the present invention. However, regardless of the design of the ESL, it will ordinarily have protruding portions such as shown at 61, 63 that define engagement surfaces that are gripped by complementary fingers 71, 73 of the holder 10 at top and bottom portions to engage and hold the ESL device. Thus, to a certain extent, the design of the ESL 60 will dictate the configuration of the interior of the holder retention elements which will generally include complementary fingers or undercuts, as necessary, to enable the ESL devices to be snapped into engagement with the holder member or slid lengthwise along the holder member from an end thereof to position the ESLs on the holder.

The ESL typically will include a battery pack 61 as shown in FIG. 3. The battery pack 61 forms part of the ESL itself insofar as pertinent to the present invention and is not itself connected to the holder.

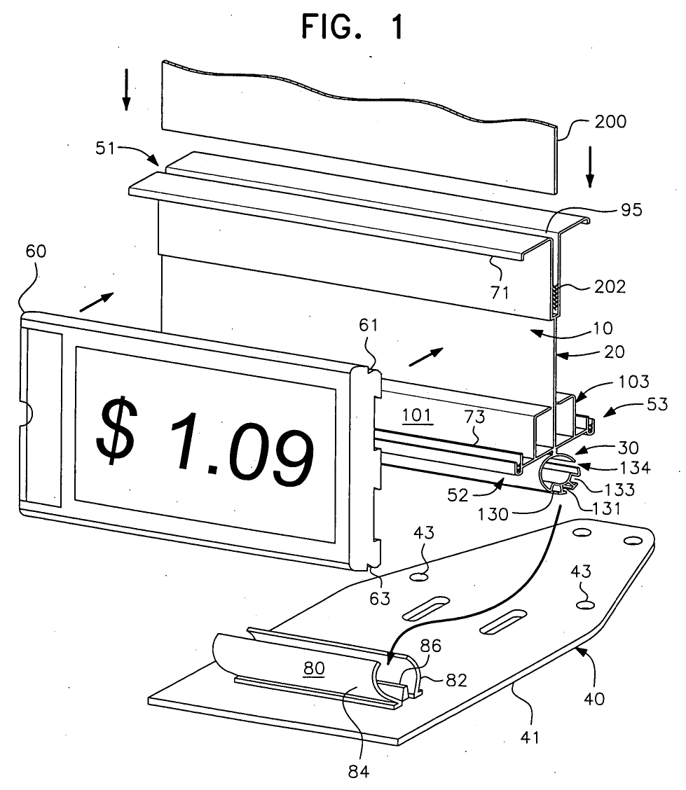

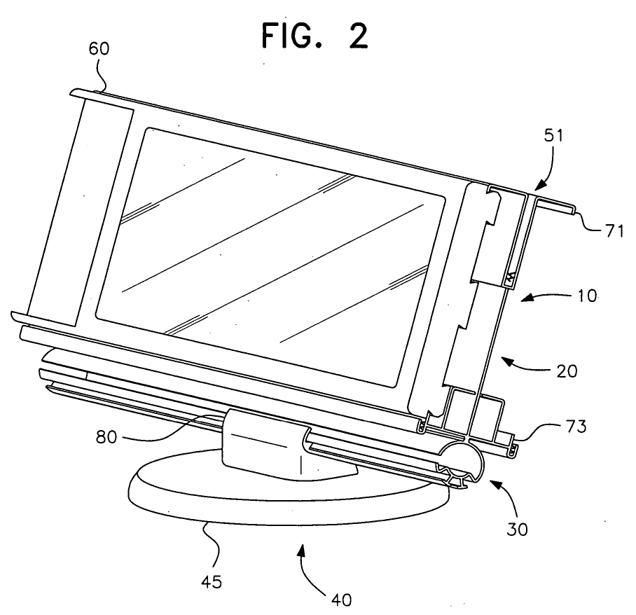

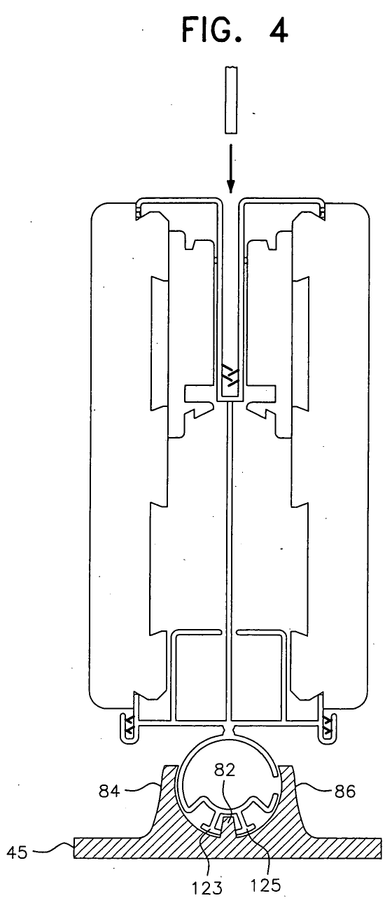

Similarly, the base or base plate 40 is not part of the present invention per se. Base plates are known in the art and were intended to support signage. In the drawings, two distinct types of base plates are depicted. In FIG. 1, the base plate 41 is a substantially planar base with holes 43 that could be used to screw the plate 41 to the top of a supporting surface, such as shelving. Alternatively, the plate 41 may rest underneath the products to be sold, such as underneath soft drink six-packs without affixing to a supporting surface. The base plate 41 can thus be freely oriented in different directions. A receptacle 80 on the base plate typically will have a ridge 82, which is shown as trapezoidal in cross-section in FIGS. 1 and 3 with semi-cylindrical walls 84, 86 that extend along the length of the plate. As shown in FIGS. 2 and 4, the base plate can be a free-standing circular plate 45 with upstanding vertical sides with a semi-cylindrical top portion 80 that includes the trapezoidal ridge 82.

It is understood that the exact configuration of the base plate receptacle 80 may vary and the ESL holder of the present invention will include a mounting portion 30 that could be varied to accommodate the different base plate configurations. It is essential only that the mounting element 30 of the holder 10 be designed to be affixed to the base plate 40 at different angular orientations which is necessary so that the ESL can be oriented in different directions and viewed from different angles.

The ESL holder 10 of the present invention includes minored image retainers for retaining an ESL on each side of the holder. See, FIG. 3. This has applicability particularly when the base plate 40 is a free-standing plate, such as the circular plates shown in FIGS. 2 and 4. Under certain circumstances, separate ESLs 60, 62 may be mounted in back-to-back relationship. See, FIG. 3.

Each side of the holder 10 includes an upper grip element 71 and a bottom grip element 73. The upper grip element 71 includes a flexible PVC finger extending downward from a horizontally-oriented flange 91 that is part of an L-shaped support 93. As is shown in FIG. 3, two L-shaped supports 93 are positioned in back-to-back relationship, but spaced apart slightly, to accommodate a promotional sign 200 to be inserted therebetween. See, for example, FIG. 1. Within the space or gap 95 defined by the back-to-back L-shaped elements are a set of flexible downwardly-oriented PVC fingers 202 which will grip the sign 200 and hold the sign in an upright position. The back-to-back L-shaped members 91, 93 are joined at the bottom and a perpendicular riser panel 95 extends therefrom. The riser panel 95 is supported by a substantially horizontally oriented base plate 97 from which the lower gripping elements extend. The lower gripping elements 73 extend perpendicular to the base plate 97 at the ends of the base plate. Integral with each gripping element 73 is a substantially U-shaped bottom portion 52, 53 with flexible PVC fingers 54 therewithin similar to those shown in the gap 95. Each of these U-shaped members define a gap also for holding signage when an ESL is not mounted on that particular side of the holder.

Extending upward from the base 97 on opposite sides of the riser panel 95 are a pair of inverted L-shaped flexible support members 101, 103 that extend along the base. These are integrally connected to the base 97, yet separated from the central riser panel 95. This enables some flexure when the ESL is mounted to the holder, and particularly when the holder is oriented in a direction that would receive the weight of the ESL thereon. See, for example, FIG. 2. These inverted L-shaped support members 101, 103 will flex slightly and engage the central riser 95 and thus provide stability.

As is shown in the drawings, the ESL holder 10 is elongated and may be of various lengths as desired. For example, the length may be approximately 8 inches. The overall height of the unit also may vary but, typically, will be between 3 to 4 inches.

The cylindrical mounting portion 30 is integral with the base 97 at the exterior face thereof. The mounting or attachment portion 30 has a circular profile, the outside diameter of which matches the inside diameter of the base member 80. The mounting portion 30 includes a cylindrical peripheral section 121 and a plurality of preferably two, T-shaped fingers 123, 125, which define three gaps 130, 131, 133. The mounting member 30 is separated at the circumference at 134 to provide some flexure when the cylinder 30 is inserted into the base plate 80.

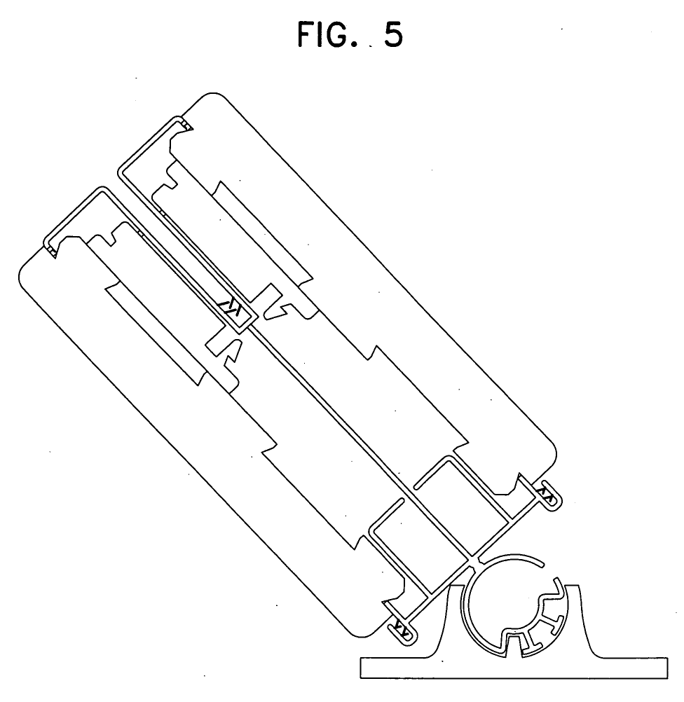

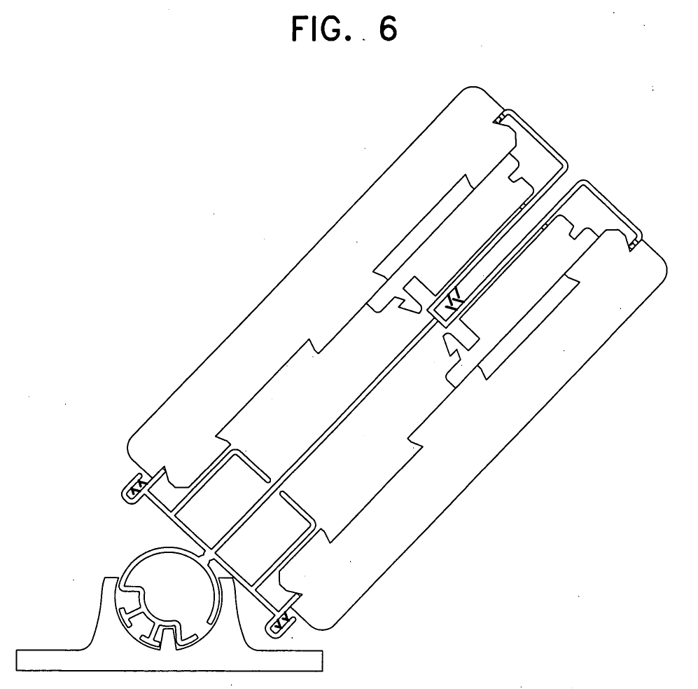

Each of the gaps 130, 131, 133 between the fingers 123, 125 may receive the ridge 82 of the base plate and, thus, the holder 10 is oriented in at least three different directions. As shown in FIG. 3 and FIG. 4, the base plate trapezoidal ridge 82 fits within the intermediate gap 131 between fingers 123 and 125 and, thus, the holder 10 is upright or substantially perpendicular to the base plate 40. As can be seen, the holder can be snapped into the gaps 130, 133 adjacent to the central gap 131 which will orient the holder 10 in substantially 60 degree directions, either clockwise or counterclockwise, depending upon which gap receives the ridge 82. See FIGS. 5 and 6.

The ESL holder may be inserted into the base plate receptacle 80 by downward pressure which compresses the member 30 to permit insertion. Alternatively, the cylindrical mounting member 30 may be slid lengthwise along the length of the receptacle 80.

It should be apparent that the receptacle 80 could include other forms of attachment structures to receive the fingers 123, 125 or gaps 130, 131, 133 of the attachment member 30. For example, the receptacle 80 could include a pair of fingers that define a gap wherein the T-shaped elements fit within the fingers and are gripped by the fingers, in a manner similar to that described in co-pending, commonly-assigned, Ser. No. 10/448,049 filed on May 30, 2003, incorporated herein in its entirety by reference. Similarly, other forms of attachment can be utilized so long as there are at least three positions for fixedly engaging the holder to the base plate.

The foregoing descriptions and drawings should be considered as illustrative only of the principles of the invention. As noted, the invention may be configured in a variety of shapes and sizes and is not limited by the dimensions of the preferred embodiment. Other similar modifications to the disclosed embodiments can also be made within scope of the instant inventive concepts. Thus, the foregoing descriptions and drawings should be considered as illustrative only of the principles of the invention.

1. An electronic shelf label (ESL) holder releasably attachable to a base member in a plurality of orientations comprising,
said ESL holder including a retaining member for gripping and retaining an ESL, and a mounting member defining a plurality of ridge-receiving recesses; and
said base member supportable by merchandise or a merchandise shelf comprising a base plate having an elongated ridge extending upwardly therefrom, wherein said ridge is selectively insertable within said ridge receiving recesses of said mounting member to orient said ESL holder at a plurality of angularly disposed positions with respect to said base member.

2. The ESL holder and base member combination of claim 1, wherein said retaining member further comprises a plurality of sign receiving elements.

3. The ESL holder and base member combination of claim 1, wherein said base plate includes a planar supporting surface for supporting said base member upon a merchandise shelf or other planar surface.

4. The ESL holder and base member combination of claim 3, wherein said plurality of ridge receiving recesses are arranged adjacent to each other and oriented angularly with respect to each other.

5. The ESL holder and base member combination of claim 4, wherein said adjacent ridge receiving recesses are disposed along an arc.

6. The ESL holder and base member combination of claim 5, wherein said mounting member has a substantially cylindrical profile and said adjacent ridge receiving recesses extend arcuately about the cylindrical profile.

7. The ESL holder and base member combination of claim 1, wherein said base plate includes a pair of arcuate walls extending upwardly from said base plate to define an upwardly oriented gap, each of said arcuate walls on opposite sides of said elongated ridge.

8. The ESL holder and base member combination of claim 7, wherein said mounting member is insertable through said upwardly oriented gap.

9. An electronic shelf label (ESL) holder releasably attachable to a base member in a plurality of orientations comprising,
said ESL holder including a retaining member having an upper gripping element and a lower gripping element for gripping and retaining an ESL, and a mounting member having an arcuate profile with a plurality of fingers extending substantially radially to define a plurality of ridge-receiving recesses; and
said base member supportable by merchandise or a merchandise shelf and comprising a base plate with a receptacle integral therewith, said receptacle having an open upper portion for receiving said mounting member, and including an elongated ridge within the receptacle at a bottom portion adjacent the base plate, wherein said ridge is selectively insertable within said ridge receiving recesses of said mounting member to orient said ESL holder within said receptacle at a plurality of angularly disposed positions with respect to said base member.

10. The ESL holder and base member combination of claim 9, wherein said base plate includes a planar supporting surface for supporting said base member upon a merchandise shelf or other planar surface.

11. The ESL holder and base member combination of claim 9, wherein said receptacle is defined by a pair of arcuate walls extending from said base plate, said walls spaced apart to define said open upper portion for receiving said mounting member.

12. The ESL holder and base member combination of claim 11, wherein said elongated ridge extends from said base plate between said arcuate walls and aligned with said open upper portion.

13. The ESL holder and base member combination of claim 12, wherein said elongated ridge is substantially trapezoidal in cross-section.

14. The ESL holder and base member combination of claim 9, wherein said retaining member includes a retaining member base plate having an upper surface and a lower surface, said lower gripping element extending upwardly from said upper surface and said mounting member extending downwardly from said lower surface so as to be insertable within said receptacle.

15. The ESL holder and base member combination of claim 9, wherein said fingers are substantially T-shaped.

16. The ESL holder and base member combination of claim 11, wherein said mounting member arcuate profile is gripped and retained by the arcuate walls of said receptacle.

17. The ESL holder and base member combination of claim 14, wherein said retaining member includes a riser panel extending upwardly from said retaining member base plate upper surface and defines an L-shaped support, said upper gripping element extending from said L-shaped support and oriented downwardly toward the retaining member base plate.

18. The ESL holder and base member combination of claim 14, wherein said retaining member includes a pair of lower gripping elements and a pair of upper gripping elements, each of the lower gripping elements extending upwardly from said retaining member base plate.

19. The ESL holder and base member combination of claim 17, wherein said riser panel includes a pair of L-shaped supports positioned in back-to-back relationship, and spaced apart to define a space for receiving a sign, each of said L-shaped supports supporting an ESL.
